(19) United States
(12) Patent Application Publication
(10) Pub. No.: US 2010/0218458 A1
(43) Pub. Date: Sep. 2, 2010

(54) Machine For Cutting Products Paper Wrapping, In Particular Of Stacks Of Covers

(75) Inventors: Gianni Benini, Final di Rero di Tresigallo (IT); Gianfranco Baldassari, Monticelli Terme di Montechiarugolo (IT)

Correspondence Address: WILLIAM J. SAPONE;COLEMAN SUDOL SAPONE P.C., 714 COLORADO AVENUE, BRIDGE PORT, CT, 06605, US

(73) Assignee: CORIMA INTERNATIONAL S.R.L., Vigarano Mainarda Ferrera (IT)

(21) Appl. No.: 12/681,383

(22) PCT Filed: Oct. 2, 2008
(86) PCT No.: PCT/IB08/02588

§ 371 Date: Apr. 2, 2010

(30) Foreign Application Priority Data
Oct. 3, 2007 (IT) BO2007A 000673

(51) Int. Cl. B65B 69/00; B26D 7/18; B26D 7/14

(52) U.S. Cl. 53/381.2; 83/102; 83/100; 83/149; 83/176

(57) ABSTRACT

Machine for cutting the paper wrapping (2) which wraps and holds together in a packing (3) at least a stack of axial-symmetrical products (4) and/or at least an extended product (4), comprising a casing (5) for containing and protecting the moving parts, which contains a cutting station (T), comprising cutting means (6), comprising in turn at least a blade (7), and means (8) for folding in longitudinal direction, substantially uniformly and towards outside a portion (9) of the side surface of the paper wrapping (2) of a packing (3′), which is disposed in the cutting station (T), said portion (9) of the side surface having a length substantially corresponding to the longitudinal extension of the same packing (3, 3′); said machine (1) comprising also moving means (61) of said blade (7) for positioning the same at the folded portion (9) of the surface of the paper wrapping (2) and for translating it along the folded portion (9) itself, so that it is longitudinally cut.

### FIELD OF THE INVENTION

The present invention relates to the technical field of the machines for removing paper wrapping from objects and products, in particular stacks of covers.

### DESCRIPTION OF THE KNOWN ART

It is known that for storage and transport reasons, the covers require packings able to hold them together, to allow their stacking and to protect them from scratches to the coating varnish.

Usually, such a packing is provided by a suitable apparatus, which approaches a determined number of covers in perpendicular direction to the extension surface of the same so that the covers are coaxially arranged with respect to each other, and then it covers them with a wrapping made in thermo-retractable plastic or paper.

It is clear that the covers, for example, destined to be seamed to suitable containers, have to be free of the wrapping containing them in order to provide loose covers to a suitable seamer.

Apparatuses for cutting plastic wrapping films are known, which comprise suitable nozzles apt to be positioned near the outer surface of the plastic wrappings where direct an overheated air flow, which provides the cutting operation.

It is known that the paper wrapping is preferred to the plastic one in some applications; it is, for example, the case of the wrappings used to wrap those covers destined to be sealed to their respective containers requiring the usage of suitable mastics, these latter being usually applied to the same covers before they are packed. The paper porosity allows in fact the gases produced by the evaporation of compounds contained in said mastics, to leak out from the packing, therefore avoiding the formation inside the same of a condensate where said compounds are dissolved.

The technical solution employed for removing the plastic wrapping film is not used for removing the paper wrappings, since it is perfectly ineffective to provide said cutting operation, because of the known differences between plastic films and paper wrappings, concerning the chemical-physical proprieties.

Currently, the apparatuses for cutting the packing paper wrapping of stacks of covers are of the type disclosed in the patent U.S. Pat. No. 4,344,268. This document describes support means, which are apt to receive packings one by one and which comprise such a shaped groove that it has a longitudinal extension parallel to the one of the packing received in the same, and a substantially V shaped transverse section.

The cutting operation is prepared by suitable pliers, apt to engage the upper portion of the paper wrapping, the pliers pinching a short portion thereof, centrally arranged between the ends of the packing. Said pliers lift said upper portion along a transverse direction with respect to the packing axis. This operation makes the upper portion of the paper wrapping move away in a vertical direction, in a measure defined by the stack of covers comprised in it.

Only in this moment, the cutting operation is provided by means of two horizontal blades, which incise the wrapping in two points arranged at its previously lifted portion and cut it in longitudinal direction, moving away with respect to each other by means of suitable moving means.

This procedure is aimed at reducing the risk that the blames incise the covers, consequently chipping them or scratching the varnish; said incision could also imply the acceleration of wear of the same blades, thus reducing their duration.

Finally, according to this technical solution, the packed cylinder of covers is pushed in a collecting tank, where the covers are extracted from the paper wrapping through the cuttings made in the same.

The described known art has some remarkable disadvantages.

A first disadvantage is that the mechanical stresses, the paper wrapping is subjected to due to the pliers engaging it, could damage it, for example by tearing it, considering the known low toughness of the paper. This is more probable because said mechanical stresses are each concentrated on an unique short portion of the wrapping.

Such probable damage could not only negatively influence the cutting operation, by making it ineffective, but also increase the risk of a great amount of cutting remainders of the wrapping, configured as chips, which remain between the covers inside the collecting tank and are conveyed with them to the sealers and/or seamers, thus compromising the functioning effectiveness.

A second disadvantage is that since said pliers engage only a short central portion of the wrapping surface, the measures of the separating vertical space between wrapping and stacks contained in it, are not constant but progressively reduce towards the two packing ends.

As a consequence, the pliers either apply such a traction force that they appreciably lift also the wrapping portions disposed at the two ends of the packing, consequently increasing the probability of tearing the wrapping itself, or there will be a significant risk of an ineffective wrapping cutting operation at the ends of the packing.

Another disadvantage is that the extraction of the covers from the paper wrapping, which is usually manually provided, not only produces a remarkable waste of time but it makes necessary the usage of dedicated workforce, implying considerable costs. Moreover, this manual extraction operation increases the risk of producing the above-mentioned “chips”, together with the respective mentioned disadvantages.

### SUMMARY OF THE INVENTION

The above-mentioned disadvantages and others more are solved by means of a machine for cutting the paper wrapping that wraps and holds together in a packing at a least a stack of axial-symmetrical products or at least an extended product, according to claim 1, comprising a casing for containing and protecting the moving parts, which contains a cutting station, comprising cutting means, which contain in turn at least a blade and means for folding in longitudinal direction, substantially uniformly, and towards outside a side surface portion of the paper wrapping of a packing arranged in the cutting station, said side surface portion having a length which substantially corresponds to the longitudinal extension of the same packing. Said machine comprises also moving means of said cutting blade for positioning the same at the folded portion of the paper wrapping surface and for translating it along the same folded portion, so as to longitudinally cut it.

Since the present invention provides means for longitudinally and substantially uniformly folding a wrapping portion which wraps along the whole packing length, it is able to overcome the known technical limits due to the fact that it provides the pinching and the vertical traction only in a short central portion of the paper wrapping surface, causing an extremely irregular lifting thereof along the longitudinal direction of the same packing.

As a consequence, the invention guarantees a regular and effective cutting along the whole length of the packing, without the slightest risk that the blade incises the products contained in the paper wrapping, thus meeting the needs of the particular technical field concerning the inventive machine.

Said longitudinally folding means comprise preferably at least a couple of upper rollers, of greater or equal length with respect to the longitudinal extension of the packing; connected to suitable actuator means and mounted on suitable supports coupled with said moving means, so that they are arranged in contact with said packing disposed in the cutting station, along a generatrix of their side surface.

The longitudinal folding of the paper wrapping is provided by mutually counter-rotating said upper rollers, so that the tangential lines between the upper rollers and the packing approach with respect to each other.

By means of this expedient, the force applied by the folding means on the paper wrapping is advantageously tangential to the packing surface and is uniformly distributed on its longitudinal extension; contrary to what happens using the known pliers, which, on a short portion of the packing surface, act a force provided also with a perpendicular component with respect to the paper wrapping surface and apply also a vertical traction on it.

As a consequence, the present technical solution substantially eliminates the risk of tearing the paper wrapping before or during the cutting, thus preventing the formation of the above-mentioned paper “chips”, and overcoming the respective disadvantages of the known art.

According to a particular aspect of the invention, the cutting station comprises at least two lower support rollers, of greater or equal length with respect to the longitudinal extension of the packings, and arranged so as to define an abutment when receiving a packing.

Said lower rollers are arranged in contact with the packing disposed in the cutting station along a generatrix of their side surface; are connected to suitable actuator means; are mounted on suitable supports associated with the casing and can be actuated in a mutual counter-rotation so that the respective tangential lines to the packing approach with respect to each other. It is to be noted that such actuation of the lower rollers is provided in phase relation with the end of said longitudinal cutting.

In this way, the cut paper wrapping is pinched by the lower rollers, by means of said counter-rotation, so that it is separated from the wrapped products.

The cut wrappings are subsequently destined to a suitable waste tank, comprised in an output station. Said output station comprises also a sucking device, which is connected to said waste tank and is apt to provide inside this latter such a depression that it is able to convey the cut wrappings. Finally, the output station comprises suitable means for moving away the products.

### BRIEF DESCRIPTION OF THE DRAWINGS

The features of the invention not emerging from the preceding description, will be better highlighted in the following, according to the claims and with reference to the appended drawings, in which:

FIG. 1 is a schematic longitudinal section of the machine according to the invention;

FIG. 2 is a schematic top view of the cutting section of the machine of FIG. 1;

FIG. 3 is a schematic cross sectioned view of FIG. 2 according to the direction IV-IV;

FIG. 4 shows a detail of FIG. 3.

### DESCRIPTION OF PREFERRED EMBODIMENTS

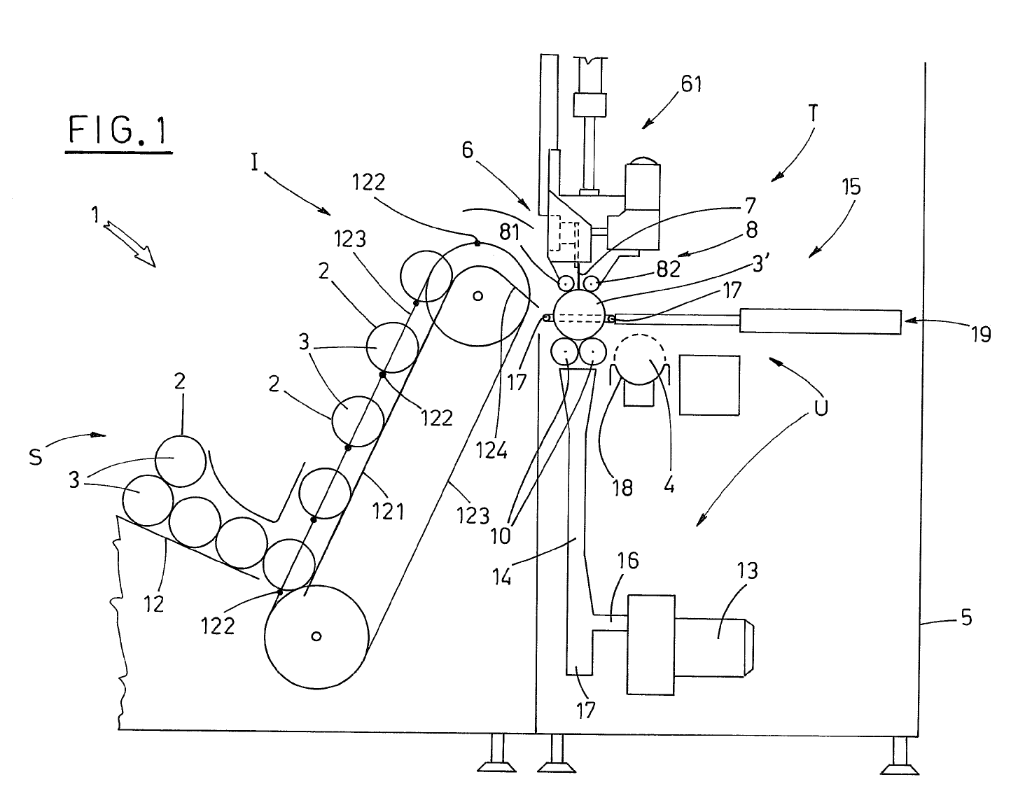

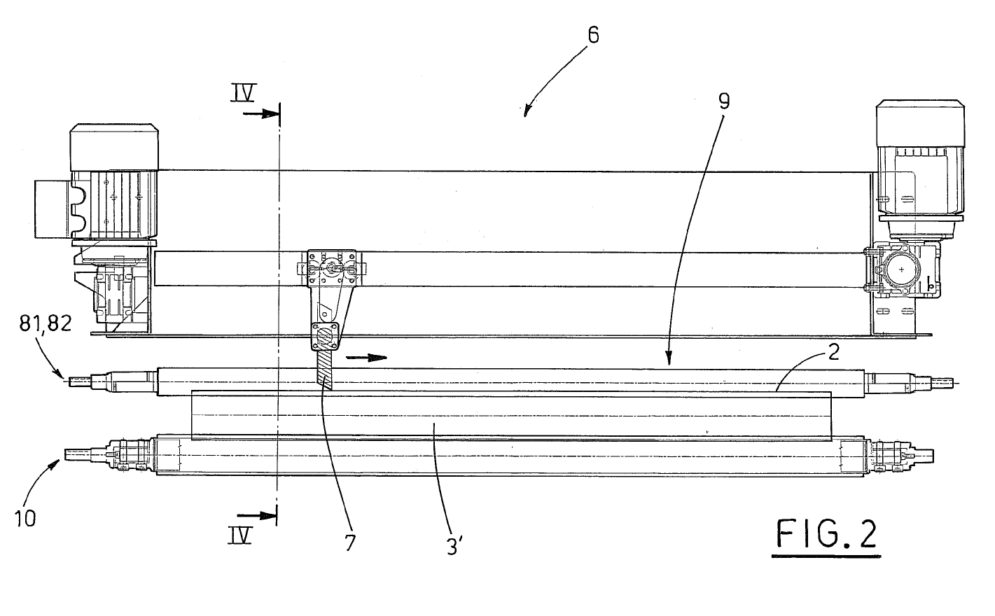

Referring to the appended figures, the reference number 1 indicates a machine for cutting the paper wrapping 2 which wraps and holds together in a packing 3 at least a stack of axial-symmetrical products 4 and/or at least an extended product 4, comprising a casing 5 for containing and protecting the moving parts, which contains a cutting station T, comprising cutting means 6, which comprise in turn at least a blade 7 and means 8 for folding in longitudinal direction, substantially uniformly and towards outside a portion 9 of the side surface of the paper wrapping 2 of a packing 3′ which is arranged in the cutting station T (see FIGS. 1 and 2), said portion 9 of the side surface having a length, which substantially corresponds to the longitudinal extension of the packing 3, 3′ itself.

Said machine 1 comprises also moving means 61 of said one blade 7 for positioning the same at the folded portion 9 of the surface of the paper wrapping 2 and for translating it along the folded portion 9 itself, so that the portion is longitudinally cut (see FIG. 4).

FIGS. 1, 2, and 3 show how the blade 7 cuts the longitudinally folded portion 9, the blade being in a position substantially perpendicular to the one of the surface of the paper wrapping 2 of said packing 3′ which is disposed in the cutting station.

Such an expedient, even representing only a particular and not limiting aspect of the invention, improves the cutting efficacy, since it avoids a possible transverse ripple with respect to the cutting of the paper wrapping 2, during its cutting, the ripple being due to the inclination of the blade with respect to said substantially perpendicular position, which could lead it either to lift or to squash the paper wrapping because it is arranged in the half-plane defined by the cutting direction or in the opposite one.

Said moving means 61 can be of any type suitable for the purpose and the FIGS. 1, 2, and 3 are only exemplary and do not limit the inventive solution.

As it is shown in FIGS. 1, 3, and 4, said cutting station T comprises two lower support rollers 10, of greater or equal length with respect to the longitudinal extension of said packing 3; are arranged so that they define an abutment when receiving a packing 3′ and so that each of said lower rollers 10 touches the packing 3′ itself along a generatrix of their side surface.

Said lower rollers 10 are connected to suitable moving means, not shown in the appended figures, since they can be of any suitable type.

The lower rollers 10 are mounted pulled over on suitable supports (not shown in the figures as yet known), which are associated with said casing 5, and are actuated in phase relation with the end of said longitudinal cutting, in such a mutual counter-rotation that the cut paper wrapping 2 of said packing 3′ disposed in the cutting station is pinched, to be separated from the wrapped products 4 (see FIG. 4).

In a preferred embodiment, said longitudinally folding means 8 comprise at least two upper rollers 81, 82 mounted distanced on suitable supports (not shown since known and obvious) coupled with said moving means 61, so that they are arranged in contact with said packing 3′ which is disposed in the cutting station T, along a generatrix of their side surface.

Also the upper rollers 81, 82 are connected to suitable actuator means, not shown since they can be of any type, provided that it is suitable for the purpose.

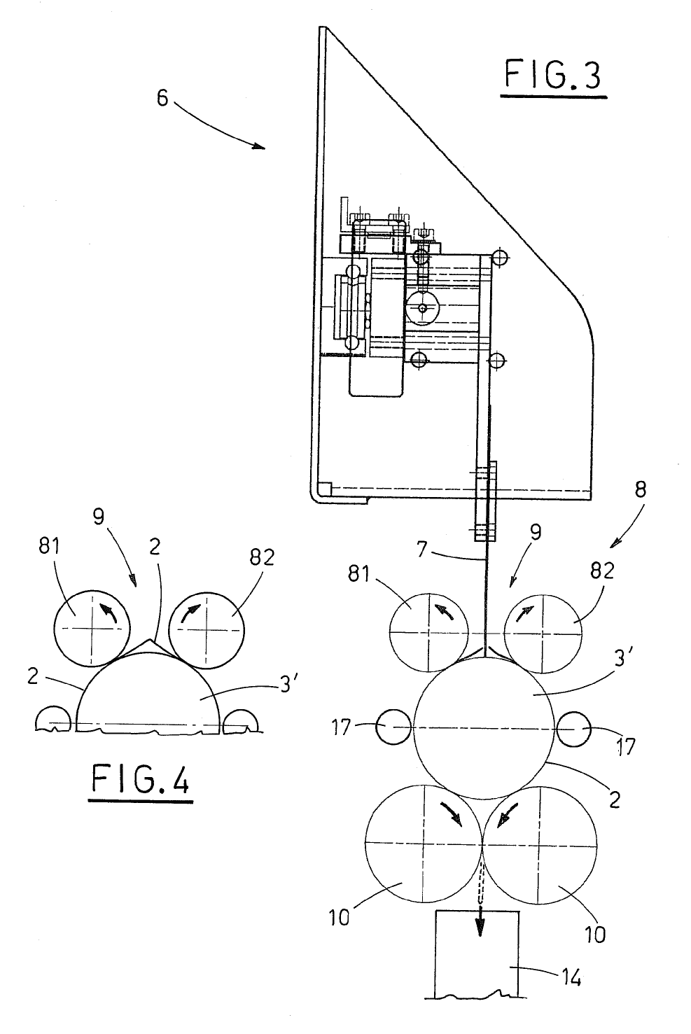

The upper rollers 81, 82 are actuated in mutual counter-rotation to provide said longitudinal folding towards outside (see FIGS. 3 and 4).

In the appended figures it is shown how, in the preferred embodiment, the axes of the lower rollers 10, of the upper rollers 81, 82 are parallel with respect to each other and to the axis of the packing 3′.

According to two different possible embodiments of the inventive object, the upper rollers 81, 82 can alternately be made idle in phase relation with the end of said longitudinal cutting, or they can be actuated in such a mutual counter-rotation that they contribute to the separation of the paper wrapping 2 from the products 4 in it wrapped, also in phase relation with the end of said longitudinal cutting.

Therefore the present technical solution provides such longitudinally and substantially uniformly folding means 8 that they not only effectively prevent the incision by means of the blade 7 of the products 4, contained in the paper wrapping 2, but above all they guarantee a regular cuffing, on the whole longitudinal extension of the packing 3′, contemporarily avoiding cutting remainders apt to potentially compromise the efficacy of the industrial processes, such products 4 are thereafter subjected to.

In another embodiment, it is possible that said moving means 61, said actuator means connected to said lower support rollers 10 and said actuator means connected to said upper rollers 81, 82, are controlled by suitable means regulating their functioning.

As shown in FIG. 1, the machine according to the invention comprises an input station I, comprising in turn a stacking tank S for the packings 3 and feeding means 12 apt to take the packing 3 one by one, in order to transfer them in said cutting station T.

Said stacking tank S, on which for example the packings 3 can be leant parallel with respect to each other, comprises a chute 11 by means of which the packings 3, only by force of gravity, are lead to said feeding means 12.

By way of example, the feeding means 12 can be made up of an inclined plane 121 along which the packings 3 are lifted, pushed by a set of bars 122 parallel to the axis of the respective packings 3, but positioned in transverse direction with respect to said inclined plane 121.

Each of said bar 122 conveys a packing 3 at a time, and it is connected at its ends to dragging means 123, which are for example two chains moved on suitable transmissions by suitable driving means, not shown since known to those skilled in the technical field relating to the machine 1.

At their top, the feeding means 12 are provided with a chute 124 which leads the packings 3, one by one ad by force of gravity, in the cutting station T.

In the shown example, the invention comprises also an output station U, comprising both sucking means 13 (shown in schematic way in FIG. 1, since known) connected to a waste tank 14 and apt to provide inside this latter such a depression that it is able to convey the cut paper wrappings 2, and means 15 for moving away the products 4, which are free of the wrapping.

In particular, said sucking means 13 is connected to said waste tank 14 by means of a suitable communicating duct 16, in the lower portion of which, inside the waste tank 14, it is provided a housing 18 for retaining the products 4 accidentally falling inside the waste tank 14.

Said moving away means 15 comprise two rods 17 apt to be arranged at the cutting station T so that the packing 3′ in it positioned, results in an intermediate position between said rods 17 and with the axis parallel to theirs (see FIGS. 1 and 4). In phase relation with said separation of the paper wrapping 2 of the packing 3′ from the products 4 contained in it, the rods 17 are perpendicularly translated with respect to their axis, so that they bring the products 4 in a distanced position with respect to the cutting station T and such that they pass by force of gravity in an output housing 18.

Moreover, the rods 17 stably retain in loco the packings 3′ which are disposed in the cutting station T and hold together the products 4, during said perpendicular translation by means of which they pass in said output housing 18.

In the shown example, the output housing 18 is provided with a concavity disposed on a side portion of an ideal cylinder having the axis parallel to the one of the products 4, said concavity being directed upwards.

Said translation of the rods 17 is provided by suitable moving means 19 apt to bring back the rods 17 at the cutting station T, in phase relation with the passage of the products 4 in said output housing 18.

Obviously, also said means 19 for moving rods 17 are apt to be controlled by said regulating means.

Finally, the products 4 supported by the housing 18, are destined outside the machine 1 by suitable ejection means which can be of any type, provided that it is suitable for the purpose.

It is intended that the preceding description is purely exemplary and not limiting, therefore possible practical variations are intended to fall in the protective scope of the invention, as defined by the preceding description and by the following claims.

1. Machine for cutting the paper wrapping (2) which wraps and holds together in a packing (3) at least a stack of axial-symmetrical products (4) and/or at least an extended product (4), comprising a casing (5) for containing and protecting the moving parts, which casing (5) contains a cutting station (T), comprising cutting means (6), the cutting means (6) comprising in turn at least a blade (7), said machine (1) being characterized in that said cutting station (T) comprises means (8) for folding in longitudinal direction, substantially uniformly and towards outside of a portion (9) of the side surface of the paper wrapping (2) of the packing (3′), which is disposed in the cutting station (T), said portion (9) of the side surface having a length substantially corresponding to the longitudinal extension of the same packing (3, 3′) and in that it comprises moving means (61) of said blade (7) for positioning the blade at the folded portion (9) of the side surface of the paper wrapping (2) and for translating it along such folded portion (9), so that it is longitudinally cut.

2. Machine according to claim 1, wherein said cutting station (T) comprises at least two lower support rollers (10), of greater or equal length with respect to the longitudinal extension of said packing (3), the rollers being so disposed as to define an abutment when receiving a packing (3′) and so that each of said lower rollers (10) touches the packing (3′) along a generatrix of the side surface of the rollers (10), said lower rollers (10) being mounted pulled over on suitable supports associated with said casing (5), being connected to suitable actuator means and being actuated in phase relation with the end of said longitudinal cutting, in such a mutual counter-rotation that the cut paper wrapping (2) of said packing (3′) which is disposed in the cutting station (T) is pinched to be separated from the wrapped products (4), the machine (1) being characterized in that said longitudinally folding means (8) comprise at least two upper rollers (81, 82) mounted distanced on suitable supports, connected to suitable actuator means and coupled with said moving means (61) so that they are disposed in contact with said packing (3′) which is disposed in the cutting station (T) along a generatrix of the side surface of the upper rollers (81,82), said upper rollers (81, 82) being actuated in mutual counter-rotation to provide said longitudinal folding towards outside.

3. Machine according to claim 2, characterized in that it comprises two upper rollers (81, 82) of greater or equal length with respect to the longitudinal extension of said packing (3).

4. Machine according to claim 2, characterized in that the upper rollers (81, 82) are made idle in phase relation with the end of said longitudinal cutting.

5. Machine according to claim 2, characterized in that said upper rollers (81, 82) are actuated in such a mutual counter-rotation that they contribute to the separation of the paper wrapping (2) from the products (4) wrapped therein, in phase relation with the end of said longitudinal cutting.

6. Machine according to claim 1, characterized in that the blade (7) cuts the longitudinally folded portion (9), while the blade (7) is in a position substantially perpendicular to the one of the surface of the paper wrapping (2) of said packing (3′) which is disposed in the cutting station.

7. Machine according to claim 1, comprising at least a sucking device connected to a waste tank (14) and apt to provide inside this latter such a depression that the tank (14) is able to convey the cut paper wrappings (2), characterized in that said sucking device is connected to said waste tank (14) by means of a suitable communicating duct (16) in the lower part of which, inside the waste tank (14), it is provided a housing (18) for retaining the products (4) accidentally falling inside the waste tank (14).
